(19) United States
(12) Patent Application Publication
(10) Pub. No.: US 2006/0080179 A1
(43) Pub. Date: Apr. 13, 2006

(54) Tolling mechanisms for electronic communications

(76) Inventors: Olanrewaju Amos, Santa Clara, CA (US); David Margono, Mountain View, CA (US)

Correspondence Address: PERKINS COIE LLP, P.O. BOX 2168, MENLO PARK, CA, 94026, US

(21) Appl. No.: 10/840,665

(22) Filed: May 5, 2004

(51) Int. Cl. G06Q 30/00

(52) U.S. Cl. 705/26

(57) ABSTRACT

A system for delivering toll-based electronic mail includes a send module for delivering a toll-based electronic message from a sender to a receiver. A receive module is utilized for receiving the toll-based electronic message. Also included is a toll module for charging a toll from the sender to the user and a payment module for paying the toll to the receiver.

### FIELD OF THE INVENTION

The present invention relates to electronic communications and more particularly to controlling unsolicited electronic communications such as spam electronic mail, advertising pop-ups, instant messaging communications, etc.

### BACKGROUND OF THE INVENTION

Spam traffic has doubled over the past three years and the spam growth rate is on the rise. In March 2003 alone, AOL trashed a billion spam emails in a single 24-hour period. Hotmail blocks 2.4 billion spam emails per day. Beyond wasting recipients' time, spam wastes server storage space and resources. Companies estimate that lost productivity, due to spam, costs billions of dollars annually.

To battle this spam, companies usually install email-filtering software. However in certain circumstances, email filtering can be ineffective. For instance a legitimate email may become lost because it was filtered and deleted before delivery occurred. For medical institutions, the filter might reject emails containing some well-known spam words such as “Viagra,” “Breast” and the like, even though the rejected email may actually be a valid non-spam email.

Other types of unsolicited electronic communications result in similar annoyance and inefficiency. One very common example are those annoying unsolicited pop-up advertisements users encounter when browsing the Internet.

In view of the foregoing, it can readily be seen that more robust systems and methods are needed to deal with the problem of unsolicited electronic communications such as spam email.

### SUMMARY OF THE INVENTION

The present invention is described and illustrated in conjunction with systems, apparatuses and methods of varying scope. In addition to the aspects of the present invention described in this summary, further aspects of the invention will become apparent by reference to the drawings and by reading the detailed description that follows.

A system for delivering toll-based electronic communications, in accordance with the present invention, includes a send module for delivering a toll-based electronic message from a sender to a receiver. A receive module is utilized for receiving the toll-based electronic message. Also included is a toll module for charging a toll from the sender to the user and a payment module for paying the toll to the receiver.

A method for delivering toll-based electronic mail, in accordance with another embodiment of the present invention, includes sending a toll-based electronic mail message to a receiver from a sender and charging a toll to the sender. The toll is then paid to the receiver of the toll-based electronic mail.

Embodiments of the invention presented are exemplary and illustrative in nature, rather than restrictive. The scope of the invention is determined by the appended claims.

### BRIEF DESCRIPTION OF THE DRAWINGS

FIG. 1 is a block diagram of an embodiment of a toll-based electronic mail communication system;

FIG. 2 is a flowchart illustrating an exemplary embodiment of a method of sending toll-based electronic mail.

FIG. 3 is a block diagram of an embodiment of a network;

FIG. 4 is a block diagram of an embodiment of a computer; and

FIG. 5 illustrates an embodiment of a medium embodying instructions for causing a processor to execute the modules of operating a process.

### DETAILED DESCRIPTION OF THE INVENTION

The present invention contemplates a variety of methods and systems and for addressing the challenges posed by unsolicited electronic communications such as spam email, pop-up advertisements, instant messaging communications, voicemail, etc. through the use of tolled electronic communications. A variation of this technology for email is being called TOLLEMAIL™. With this approach, instead of filtering and/or blocking certain communications, emails or email addresses, the TOLLEMAIL system creates a tolling mechanism around the email transportation system by which the email senders can be charged for the content they send out, provided it meets the criteria set for spam. By putting a nominal fee on advertisement-type email, the number of spam will decrease dramatically. The toll charge will be distributed among the stakeholders in the system including the recipient who tolled the message in the first place. This approach will not only decrease the amount of spam, it will also open up a new marketing channel for companies that are willing to pay to send advertising via email.

TOLLEMAIL may be implemented on top of an existing email server. TOLLEMAIL Transfer Protocol (TMTP) is built upon the SMTP (simple mail transfer protocol) technology and is able to handle regular emails as well as toll emails. Toll email is a type of email specifically designed for use in TOLLEMAIL. In the context of the present invention, it should be understood that the terms “email”, “electronic mail” and various combinations and permutations refer to a message sent electronically.

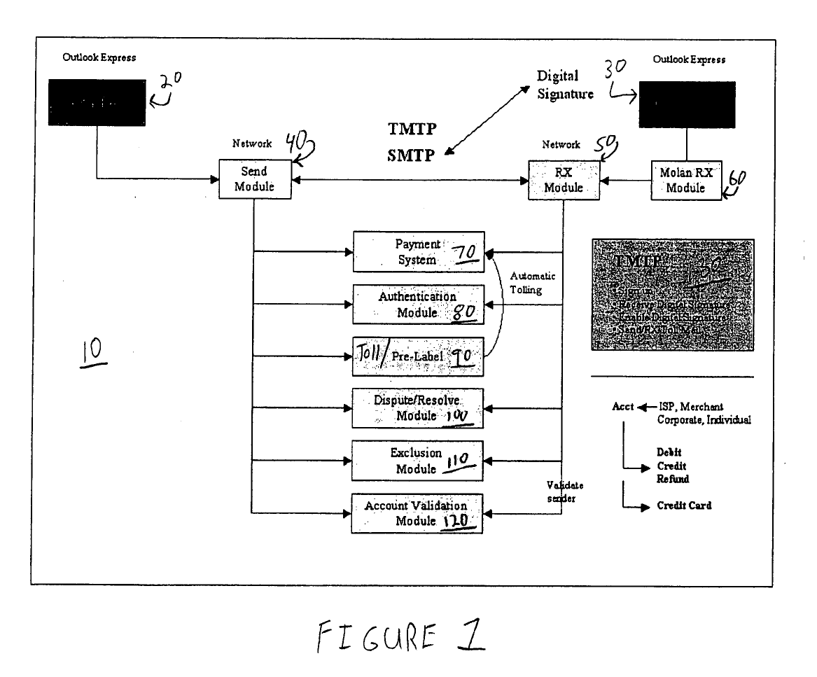

The invention may be implemented in various embodiments. FIG. 1 is a block diagram of an embodiment of a toll-based electronic mail communication system 10. Included in system 10 is a sender 20 of email, a receiver 30 of email, a send module 40, and receive modules 50 and 60. Also included is a payment module 70, authentication module 80, toll module 90, dispute/resolve module 100, exclusion module 110, account validation module 110 and registration module 130.

The registration module 130 registers all users of the system 10. Registration can be individual registration or group registration. Information obtained during individual registration includes email address(es) to register, capability to register—send, receive or both and payment information—credit card, ACH (automated clearing house) account, Tollemail acct. Information obtained during a group registration includes email domain to register, capability to register—send, receive or both and group type—ISP, Corporation, user group. A group registration module (not shown) would also be able to register individual members.

The send module 20 is employed for the sending of TOLLEMAIL messages. This includes generation of a TMTP message based on a regular SMTP message and working with SMTP mail clients to generate TMTP messages. The send module can operate in a stand-alone or a network version.

The receive module 50 is used to support receiving of TOLLEMAIL messages, message filtering and tolling. The receive module 50 also decodes TMTP messages, supports most popular mail clients (Outlook Express, for example), filters incoming messages based on user options and supports tolling of incoming messages. Similar to the send module 40, the receive module 50 can also operate in a stand-alone or a network version.

The toll module 90 is used to support generation of tolling action based on TMTP message credentials. A tolled message will have the tolled account charged the appropriate toll amount. The toller/receiver 30 will be credited with the appropriate amount. Toll charges may vary depending on message category and user category, individual or group.

The present invention also contemplates that the receiver may share the toll or that the toll may be paid to a third party such as the receiver's employer or the actual owner of the computer. For example, pay-for-use computers such as those resident in Internet cafes or such, may force recipients to receive spam and advertisement pop-ups as part of the use agreement, but keep the toll.

The authentication module 80 executes identity verification services. Authentication and non-repudiation are key to successful operation of the TOLLEMAIL system. Toll mail uses a digital signature to authenticate the sender 20 of a particular email. Each user (20 and 30) will be given a digital certificate, to install on his/her computer, when they register with an Internet service provider (ISP/not shown). Every email sent from the ISP will be encrypted with the public key from the user's digital certificate. Upon receiving the email, the authentication module 80, in conjunction with the registration module 130, will match the encrypted message with the key to authenticate the user.

For the purpose of the present invention, emails generated in system 10 are grouped into three different categories: regular email, pre-label email/registered ads and spam/junk email. Pre-label email/registered ads are emails that are sent as a registered toll mail, so the toll module 90 will charge a predetermined fee for each occurrence of such email. If the receiver 30 opens the pre-label email, the toll will be higher and the receiver will collect more money. The payment module 70 routes the appropriate amount of funds to the receiver 30. This is to ensure that the registered ads will actually reach its target and is therefore more effective than regular email. An automated payment option may be used to expedite the payment process such as the “Verified By Visa” program offered by VISA USA to authenticate the sender and to ensure payment to the recipient of the emails. The payment module 70 will use the certificate to authenticate the sender 20 and automatically charge a predetermined fee for each received toll email received from that sender 20.

If a receiver 30 believes that he/she has received an unregistered ad or spam, he/she can report it to the dispute/resolve module 100. These emails will be collected and the sender will be fined a higher fee than a registered toll mail. This action is necessary to discourage people from abusing system 10. The sender 20 however will have an opportunity to dispute the report, and must be able to provide proof that the user had previously agreed to receive these types of email. Repeat offenders will be put in the exclusion module 110 and will be excluded from using system 10. In addition, an ISP may be informed of the behavior and an action can be taken on that particular sender.

Every user must register with the registration module 130 before they can start using the system. Account validation works the same for both sender 20 and receiver 30. Account validation is preferably done on the ISP level/registration module 130 and not the individual level. The registration module 130 should be able to recognize the user and authenticate the user based on their certificates. The account validation module 120 will rely on the information given by the registration module 130 and will not pursue authentication for an individual user.

Each user of system 10 will have a list of email addresses to be excluded from filtering and that list is contained in the exclusion module 110. Email from users on the exclusion list will be displayed to the user regardless of whether they are registered with the system 10. In an alternative embodiment, the exclusion list can be maintained on a user's computer and not on a network in the form of the exclusion module 110.

One skilled in the art will appreciate that system 10 can be deployed via downloadable versions for use on individual computers, entirely on a network or a combination thereof.

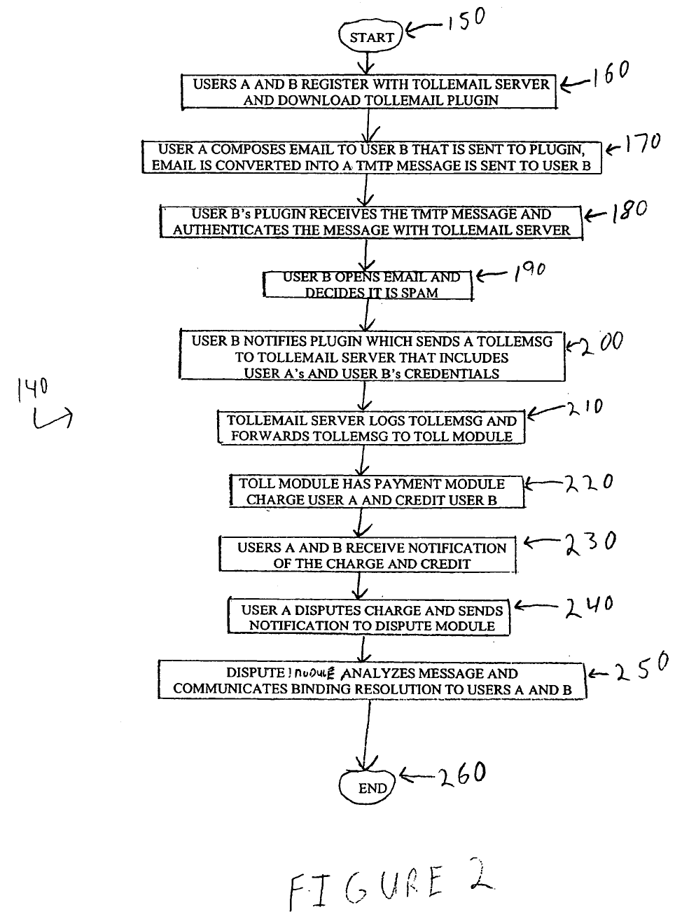

An example of how the invention functions will now be presented. FIG. 2 is a flowchart illustrating an exemplary embodiment of a method 140 of sending toll-based electronic mail. Those skilled in the art will readily understand how the disclosed methods of the present invention apply to other forms of electronic communication. After a start operation 150, users “A” and “B” register with a TOLLEMAIL and download a plug-in at operation 160. User A then composes an email to be sent to user B. The message is converted into a TMTP-type message and is sent to user B via operation 170. The message is then received and is authenticated at operation 180. At this point user A has incurred a toll for sending the message. User B opens the mail, at operation 190, and decided that is spam. Since user B opened the mail, the toll incurred by user A is automatically increased.

Since user B believes that the message is unwarranted, the necessary components are notified at operation 200. The toll module then levies an additional toll on user A and gives a credit to user B via operations 210, 220 and 230. In a preferred embodiment, the additional toll is greater than the regular toll for a receiver opening a message. However, user A does not agree with user B's assessment regarding the sent message. Therefore, user A disputes the charge at operation 250. The dispute module then resolves the issue at operation 250 after which method 140 ends.

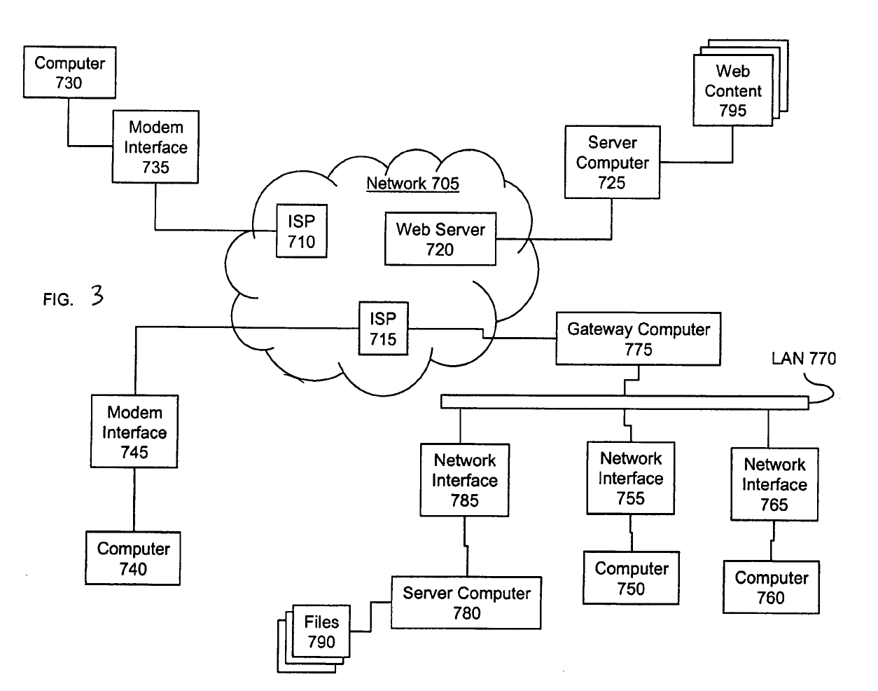

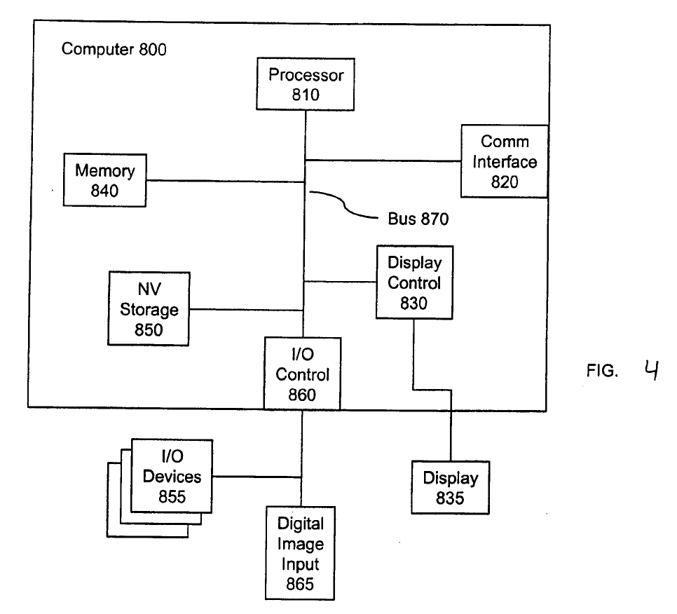

The following description of FIGS. 3-4 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 3 is a block diagram of an embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Internet service providers (ISP) typically provide access to the Internet 705, such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 that is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP that provides access to the Internet for client systems. The web server 720 is shown coupled to the server computer system 725 which itself is coupled to web content 795, which can be considered a form of a media database. While two computer systems 720 and 725 are shown in FIG. 8, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 that can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 8, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 that can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 4 is a block diagram of an embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 that can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems that have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 9, such as certain input or output devices. A typical computer system will usually include at least a processor, memory, and a bus coupling the memory to the processor.

In addition, the computer system 800 is controlled by operating system software that includes a file management system, such as a disk operating system, which is part of the operating system software. One example of an operating system software with its associated file management system software is the family of operating systems known as Windows® from Microsoft Corporation of Redmond, Washington, and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to apparatus for performing the operations herein. This apparatus may be specially constructed for the required purposes, or it may comprise a general-purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

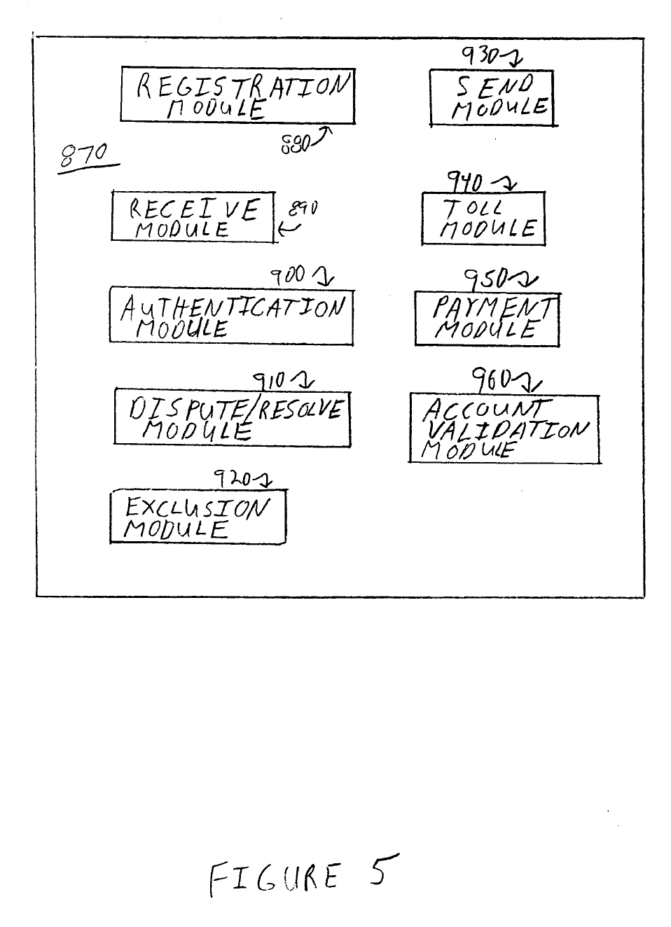

The invention may be embodied as part of a machine-readable medium. FIG. 5 illustrates an embodiment of a medium 870 embodying instructions for causing a processor to execute the modules of operating a process. A medium may be a single piece of media or a collection of media, without materially changing the medium. This medium is machine-readable, allowing an associated processor to execute instructions embodied therein.

Medium 870 includes a registration module 880, a receive module 890, an authentication module 900, a dispute module 910 and an exclusion module 920. Also included is a send module 930, a toll module 940, a payment module 950 and an account validation module 960. One skilled in the art will recognize that various components of medium 870 can be duplicated elsewhere, for example on a network or individual computers.

In practice, two or more users will register with module 880 and can send and receive messages via modules 930 and 890. As part of delivery of a message, the identity of the receiver and sender is verified with module 900. Module 960 is used for verifying that registered users have credentials to use the system. When a user sends a message, a toll is imposed by module 940 and the receiver is paid via module 950. If the receiver opens the message, the toll is automatically increased. In an alternate embodiment, the fee paid to the receiver (and conversely the toll levied to the sender) is also increased in order to induce the receiver into reading the message.

If the receiver believes that the message is spam, module 910 is alerted and module 940 imposes an additional toll on the sender. The receiver in turn is credited with the additional toll. In a preferred embodiment, the additional toll is greater than the toll for a receiver reading a message. The sender also has recourse in disputing the additional toll through use of module 910. Also included in module 870 is the exclusion module 920 that is used for preventing users from using the system. This can, for example, be a sender that repeatedly sends spam messages that do not fit the preferences of a receiver.

This invention potentially allows for a drastic reduction in the spread of spam messages and other unsolicited electronic communications. It can also potentially provide a robust system for credible distribution of advertising to end-users that specifically request such material.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

What is claimed is:

1. A method for delivering and controlling electronic communications comprising:
sending an electronic communication from a receiver to a sender;
determining whether said electronic communication is subject to a toll;
when appropriate, charging a toll to said sender; and
when appropriate, delivering said electronic communication to said sender.

2. A method for delivering and controlling electronic communications as recited in claim 1 wherein said electronic communication is an email.

3. A method for delivering and controlling electronic communications as recited in claim 1 wherein said electronic communication is an electronic communication resulting from said receiver accessing a web page.

4. A method for delivering and controlling electronic communications as recited in claim 3, wherein said electronic communication is a pop-up advertisement.

5. A method for delivering and controlling electronic communications wherein it is appropriate to charge a toll to said sender when said electronic communication is unsolicited.

6. A method for delivering and controlling electronic communications as recited in claim 5, wherein whether said electronic communication is unsolicited is defined at least in part by said receiver.

7. A method for delivering and controlling electronic communications as recited in claim 6, wherein whether said electronic communication is unsolicited is defined at least in part by a third party.

8. A method for delivering and controlling electronic communications as recited in claim 1 wherein when said electronic communication is subject to said toll, delivering said electronic communication to said sender is appropriate only if said toll is paid by said sender or a third party.

9. A method for delivering and controlling electronic communications as recited in claim 8 wherein when said electronic communication is subject to said toll, delivering said electronic communication to said sender is appropriate only if said receiver is willing to accept said toll and receive said electronic communication.

10. A method for delivering toll-based electronic mail comprising:
sending a toll-based electronic mail message to a receiver from a sender;
charging a toll to the sender; and
paying the toll to the receiver.

11. The method as recited in claim 10 wherein the toll is higher if the receiver opens the toll-based electronic mail message.

12. The method as recited in claim 11 wherein the sender is charged an additional toll to the receiver if the receiver considers the toll-based electronic mail message to be a spam electronic mail message.

13. The method as recited in claim 12 wherein the receiver is paid the additional toll.

14. The method as recited in claim 12 wherein the additional toll is higher than the toll for receiving and reading the toll-based electronic mail message.

15. The method as recited in claim 12 wherein the sender may provide proof that the receiver requested toll-based electronic mail messages, in order to reverse the additional toll.

16. The method as recited in claim 12 wherein the sender is prohibited from sending additional toll-based electronic mail messages if multiple spam electronic mail messages, initiated by the sender, are reported by one or more receivers.

17. The method as recited in claim 10 wherein the toll-based electronic message is sent in a toll email transfer protocol.

18. The method as recited in claim 10 wherein a digital signature is used to authenticate the sender of the toll-based electronic message.

19. A system for delivering toll-based electronic mail comprising:
a send module for delivering a toll-based electronic message from a sender to a receiver;
a receive module for receiving the toll-based electronic message;
a toll module for charging a toll to the sender; and
a payment module for paying the toll to the receiver.

20. The system as recited in claim 19 wherein the toll module charges a higher toll if the receiver opens the toll-based electronic mail message.

21. The method as recited in claim 20 wherein the toll module charges an additional toll, from the sender to the receiver, if the receiver considers the toll-based electronic mail message to be a spam electronic mail message.

22. The method as recited in claim 21 wherein the payment module pays the additional toll to the receiver.

23. The method as recited in claim 21 wherein the additional toll is greater than the toll for receiving and opening the toll-based electronic mail message.

24. The system as recited in claim 21 further comprising a dispute/resolve module to allow the sender to provide proof that the receiver requested toll-based electronic mail messages, in order to reverse the additional toll.

25. The system as recited in claim 21 further comprising an exclusion module for preventing the sender from sending additional toll-based electronic mail messages if multiple spam electronic mail messages, initiated by the sender, are reported by one or more receivers.

26. The system as recited in claim 19 wherein the toll-based electronic message is sent in a toll email transfer protocol.

27. The system as recited in claim 19 further comprising an authentication module for ensuring an identity of the sender via a digital certificate.
